(19) United States
(12) Patent Application Publication
(10) Pub. No.: US 2012/0296527 A1
(43) Pub. Date: Nov. 22, 2012

(54) ACTUATION JUDGMENT APPARATUS FOR PASSENGER PROTECTION CONTROL DEVICE

(75) Inventors: Atsuhiro KOGUCHI, Saitama-shi (JP); Toshinori Yagi, Saitama-shi (JP)

(73) Assignee: CALSONIC KANSEI CORPORATION

(21) Appl. No.: 13/472,865

(22) Filed: May 16, 2012

(30) Foreign Application Priority Data
May 20, 2011 (JP) 2011-113416

(51) Int. Cl. B60R 21/01

(52) U.S. Cl. 701/46

(57) ABSTRACT

An actuation judgment apparatus for a passenger protection control device can optimally judge a need for actuating a passenger protection device. The actuation judgment apparatus may comprise an integrator for integrating the horizontal acceleration and a judgment circuit in a main control unit is configured to change a threshold for the actuation of the passenger protection device based on a value obtained by integrating the horizontal acceleration at the integrator in order to reduce the error rate in assessing that a trip-over event has occurred.

### TECHNICAL FIELD

The present invention relates to an actuation judgment apparatus for a passenger protection control device, which can optimally judge an actuation of a passenger protection device.

### BACKGROUND

Recently, vehicles such as automobiles are equipped with a passenger protection device for protecting passengers in an emergency. Furthermore, a passenger protection control device for controlling the passenger protection device is also equipped in vehicles. This passenger protection control device is equipped with an actuation judgment apparatus for judging a situation where the passenger protection device should be actuated. (Refer to JP-A-2003-112598)

FIG. 6 is a diagram showing an actuation judgment apparatus 1 for a passenger protection control device of the background art.

The actuation control apparatus 1 is provided with a main control part 4 which has an angle speed sensor 2 and a judgment circuit 3. The angle speed sensor 2 is able to detect a roll angle speed in a vehicle movement direction. The judgment circuit 3 is adapted to calculate a roll angle by integrating the roll angle speed detected by the angle speed sensor 2; to judge whether or not to actuate the passenger protection device by comparing the roll angle, the roll angle speed and a predetermined threshold for actuation; and to generate an actuation signal.

The actuation control apparatus 1 is also provided with a safing sensor part 9 which includes a horizontal acceleration sensor 5 that can detect the acceleration in a vehicle width direction, and a horizontal accelerometer 6 that can generate an actuation signal based on the horizontal acceleration, or a horizontal deceleration (negative acceleration), detected by the horizontal acceleration sensor 5.

The safing sensor part 9 can be configured, as necessary, with a vertical acceleration sensor 7 that can detect the acceleration in a vertical direction and a vertical accelerometer 8 that can generate an actuation signal based on the vertical acceleration (or a vertical deceleration, as the case may be) detected by the vertical acceleration sensor 7.

Moreover, the actuation control apparatus 1 is provided with an output logic part 13 including an AND circuit 12. The AND circuit 12 is configured to output an actuation signal to an actuator 14 that actuates the passenger protection device, only if both actuation signals from the judgment circuit 3 in the main control part 4 and from the horizontal accelerometer 6 in the safing sensor part 9 are input into the AND circuit 12 at the same time.

Meanwhile, in a ease where the sating sensor part 9 includes the vertical acceleration sensor 7 and the vertical accelerometer 8 as referred to above, the output logic part 13 further includes an OR circuit 11 which outputs an actuation signal to the AND circuit 12 when the actuation signal from either the horizontal accelerometer 6 or the vertical accelerometer 8 is input into the OR circuit 11. In that case, the AND circuit 12 is configured to output an actuation signal to the actuator 14 if both actuation signals from the judgment circuit 3 in the main control part 4 and from the OR circuit 11 are input into the AND circuit 12 at the same time.

Hereinafter, the operation of the actuation control apparatus 1 of the passenger protection control device is described.

First, the angle speed sensor 2 detects the roll angle speed in the vehicle movement direction at the main control part 4.

Next, the judgment circuit 3 calculates the roll angle by integrating the roll angle speed detected by the angle speed sensor 2, and judges whether or not to actuate the passenger protection device by comparing the roll angle, the roll angle speed and the predetermined threshold for actuation, and then generates the actuation signal.

At the safing sensor part 9, the horizontal acceleration sensor 5 detects the acceleration in the vehicle width direction and the horizontal accelerometer 6 generates the actuation signal based on this detected horizontal acceleration.

At the output logic part 13, the AND circuit 12 outputs the actuation signal to the actuator 14 if both actuation signals from the judgment circuit 3 in the main control part 4 and from the horizontal accelerometer 6 in the safing sensor part 9 are input into the AND circuit 12 at the same time. Thereby, the passenger protection apparatus is actuated to protectively restrain the passenger.

In a case where the safing sensor part 9 includes the vertical acceleration sensor 7 and the vertical accelerometer 8, the vertical acceleration sensor 7 detects the acceleration in the vertical direction and the vertical accelerometer 8 generates the actuation signal based on this detected vertical acceleration.

At the output logic part 13, the OR circuit 11 outputs the actuation signal when the actuation signal from either the horizontal accelerometer 6 or the vertical accelerometer 8 is input into the OR circuit 11.

And then, the AND circuit 12 outputs the actuation signal to the actuator 14 if both actuation signals from the judgment circuit 3 in the main control part 4 and from the OR circuit 11 in the safing sensor part 9 are input into the AND circuit 12 at the same time. Thereby, the passenger protection apparatus is actuated to protectively restrain the passenger.

Actuation of the passenger protection apparatus may be roughly categorized into three rollover conditions: a trip-over event, a climb-over event and a fall-over event. The trip-over event causes the roll angle speed to change rapidly, the climb-over event causes the roll angle speed to change moderately, and the fall-over event causes the roll angle speed to change slowly.

The main control part 4 is configured to judge these three rollover conditions holistically.

Additionally, the safing sensor part 9 is configured to judge the trip-over event with the horizontal acceleration sensor 5 and the horizontal accelerometer 6, and the climb-over event and the fall-over event with the vertical acceleration sensor 7 and the vertical accelerometer 8.

Incidentally, because the trip-over event is a situation that causes the roll angle speed to change rapidly, the actuation of the passenger protection apparatus on the trip-over event needs to be judged more quickly than the moderate rollover conditions such as the climb-over event and fall-over event.

Accordingly, the horizontal acceleration 6a either detected by the horizontal acceleration sensor 5 or determined by the horizontal accelerometer 6 in the safing sensor part 9 is configured to be input into the judgment circuit 3 in the main control part 4, and the judgment circuit 3 lowers the threshold for actuation when the horizontal acceleration 6a exceeds a predetermined threshold for the horizontal acceleration.

By lowering the threshold for actuation in a case where the horizontal acceleration 6a exceeds the predetermined threshold for the horizontal acceleration, the judgment of the actuation of the passenger protection apparatus by the main control part 4 occurs more quickly, for example, in the trip-over event that is highly relevant to the horizontal acceleration 6a.

The horizontal acceleration 6a is normally accompanied by an oscillatory waveform 6a′ (dual amplitude waveform), which is not relevant to the horizontal acceleration 6a caused by the trip-over event. The threshold for actuation may be lowered when the oscillatory waveform 6a′ exceeds the predetermined threshold x for the horizontal acceleration as shown in FIG. 7, and therefore it causes the main control part 4 to have an improper judgment. As a result, there have been problems that the oscillatory waveform 6a′ may lead the passenger protection apparatus to an improper actuation by taking the horizontal acceleration 6a itself as the criterion for the actuation judgment by the main control part 4, and to the difficulty in making the actuation judgment by the main control part 4 quicker by lowering the threshold x for the horizontal acceleration.

Incidentally, the above-mentioned oscillatory waveform 6a′ is normally generated by a comparatively major impact unaccompanied by deformation of an object and a permanent movement, such as closing a vehicle door suddenly, and punching a console, for example.

### SUMMARY

In view of the above, it is desirable to remove any influence of the oscillatory waveform 6a′, which is not relevant to the horizontal acceleration 6a caused by the trip-over event, from the actuation judgment by the main control part 4.

To solve the above-mentioned problems, embodiments of the present invention can include providing an actuation judgment apparatus for a passenger protection control device, in which an integrator is included for integrating a horizontal acceleration detected by a horizontal acceleration sensor and/or a horizontal acceleration coming through a horizontal accelerometer at a safing sensor part, and a judgment circuit in a main control part is configured to temporarily change a threshold for actuation based on a value obtained by integrating the horizontal acceleration at the integrator.

Using the embodiments of the invention, the improper actuation judgment, which may be caused by using the horizontal acceleration itself, can be avoided by using the value obtained by integrating the horizontal acceleration.

### BRIEF DESCRIPTION OF THE DRAWINGS

FIG. 1 is a diagram showing an actuation judgment apparatus for a passenger protection control device according to an embodiment of the present invention.

FIG. 2 is a line graph showing the rollover conditions of the vehicle and the threshold for actuation. The graph shows “Roll Angle” in the horizontal axis and “Roll Angle Speed” in the vertical axis.

FIG. 3 is a line graph showing the status that the threshold for actuation is lowered. The graph shows “Roll Angle” in the horizontal axis and “Roll Angle Speed” in the vertical axis.

FIG. 4 is a line graph showing integrated values of the horizontal acceleration caused by the trip-over event and the oscillatory waveform which is not relevant to the horizontal acceleration. The graph shows “Time” in the horizontal axis and “Integrated Value of Acceleration” in the vertical axis.

FIG. 5 is a flowchart showing a procedure carried out by the actuation judgment apparatus.

FIG. 6 is a diagram showing an actuation judgment apparatus for a passenger protection control device of the background art.

FIG. 7 is a line graph showing a horizontal acceleration caused by the trip-over event and an oscillatory waveform which is not relevant to the horizontal acceleration. The graph shows “Time” in the horizontal axis and “Acceleration” in the vertical axis.

### DETAILED DESCRIPTION OF THE INVENTION

Hereinafter, embodiments of the present invention will be described with reference to the accompanying drawings.

### Embodiment

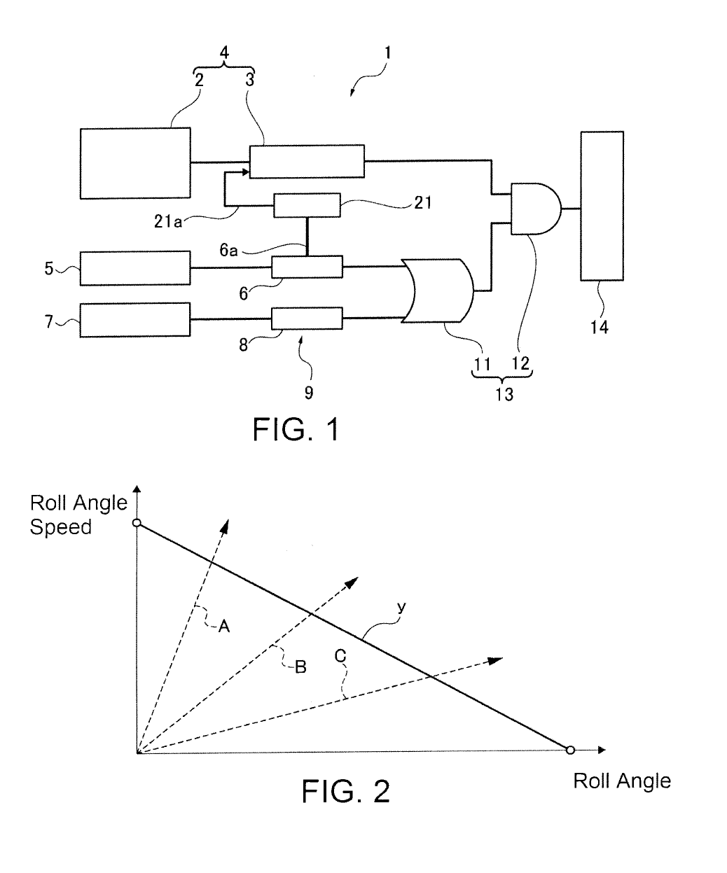

FIGS. 1-5 show an embodiment of the present invention.

A passenger protection device is equipped in a vehicle, such as an automobile, for protecting a passenger in an emergency, and a passenger protection control device is also equipped for controlling the passenger protection device. Furthermore, the passenger protection control device is provided with an actuation judgment apparatus 1 that judges whether or not to actuate the passenger protection device.

FIG. 1 is a diagram showing the actuation judgment apparatus 1 for the passenger protection control device according to an embodiment of the present invention.

The actuation control apparatus 1 is provided with a main control unit 4 which has an angle speed sensor 2 and a judgment circuit 3, which circuit 3 may be programmed control. The angle speed sensor 2 is able to detect a roll angle speed in a vehicle movement direction. The judgment circuit 3 is adapted to calculate a roll angle by integrating the roll angle speed detected by the angle speed sensor 2; to judge whether or not to actuate the passenger protection device by comparing the roll angle, the roll angle speed and a predetermined threshold y for actuation (see FIG. 2, as the case may be); and to generate an actuation signal.

The actuation control apparatus 1 is also provided with a safing sensor part 9 which includes a horizontal acceleration sensor 5 that can detect the acceleration in a vehicle width direction, and a horizontal accelerometer 6 that can generate an actuation signal based on the horizontal acceleration (which is understood to include deceleration, as the case may be) detected by the horizontal acceleration sensor 5.

Moreover, the actuation control apparatus 1 is provided with an output logic part 13 including an AND circuit 12. In the case where the actuation control apparatus 1 does not include elements 7, 8, and 11, the AND circuit 12 is configured to output an actuation signal to an actuator 14 that actuates the passenger protection device, if both actuation signals from the judgment circuit 3 in the main control part 4 and from the horizontal accelerometer 6 in the safing sensor part 9 (the horizontal accelerometer 6 being directly connected to the AND circuit 12 in such an alternative) are input into the AND circuit 12 at the same time.

Here, the term vehicle primarily refers to, but is not limited to, a car. A commercial car, a bus, a truck, a construction vehicle, a farm vehicle, and so on, could be widely included, for example. Further, the passenger protection device could be an air-bag device and/or a seat belt restraint device, and the like. In a case where the passenger protection device is an air-bag device, the actuator 14 could be an ignition device. Meanwhile, the actuation judgment apparatus 1, excluding the sensors such as the angle speed sensor 2, the horizontal acceleration sensor 5 and a vertical acceleration sensor 7 to be described later, could be configured either as hardware (such as logic circuits) or software programmed to carry out the functionality, e.g., a control unit having programmed software.

For the embodiment of the present invention, the following configuration is provided.

### <Configuration 1>

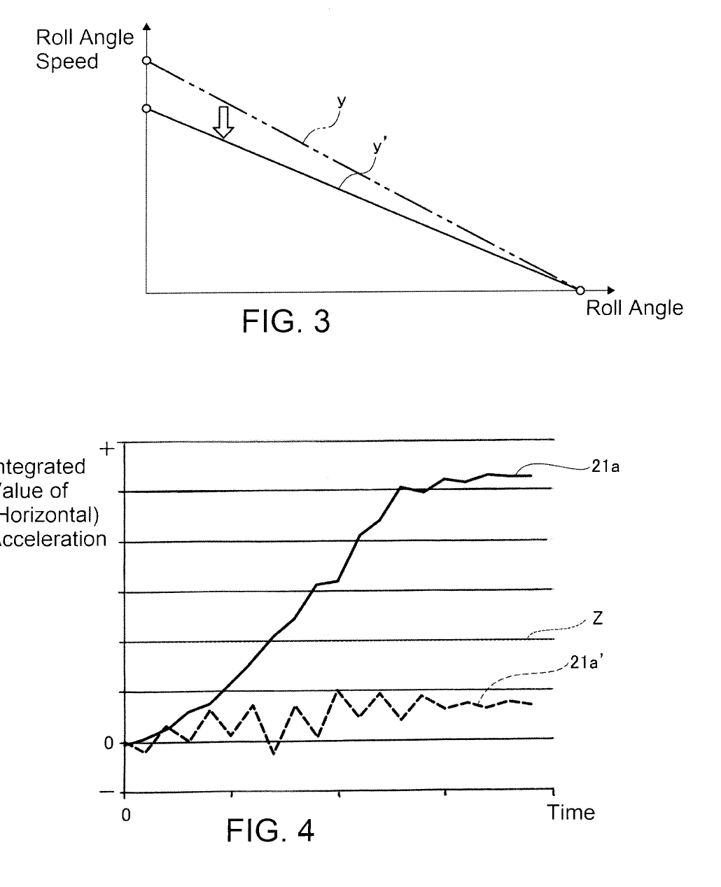

An integrator 21 (an integrator for detecting the trip-over event) is provided in which a horizontal acceleration 6a detected by the horizontal acceleration sensor 5 or determined by the horizontal accelerometer 6 is integrated. The judgment circuit 3 in the main control part 4 is configured so as to be able to change the threshold y for the actuation temporarily based on a value 21a, which is obtained by integrating the horizontal acceleration 6a at the integrator 21 (see the threshold y′ for the actuation in FIG. 3).

In a possible embodiment, using the horizontal acceleration 6a detected by the horizontal acceleration sensor 5 for integration at the integrator 21 allows the advantage of using raw data detected by the sensor without any time lag. In another case where the horizontal acceleration 6a determined by the horizontal accelerometer 6 is used for integration at the integrator 21, this permits using processed usable data through a noise filter, and the like. In addition, other embodiments are possible, such as including the integrator 21 as part of the logic or programmed control internal to the judgment circuit 3 rather than externally as shown in FIG. 2.

### <Configuration 2>

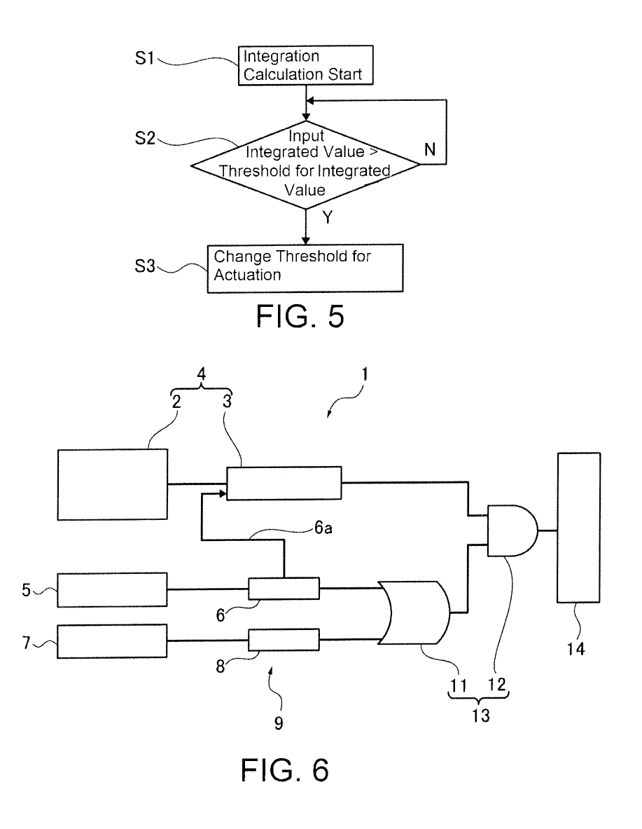

More specifically, the judgment circuit 3 in the main control part 4 is adapted to compare the value 21a output from the integrator 21 and a predetermined threshold z for an integrated value (see FIG. 4) and lower the threshold y for the actuation temporarily (see the threshold y′ for the actuation in FIG. 3) during the period of time when the value 21a exceeds the threshold z for the integrated value (see FIG. 5). The judgment circuit 3 raises the threshold y for the actuation back to its pre-lowered value (see the threshold y for the actuation in FIG. 3) when the value 21a no longer exceeds the threshold z for the integrated value.

### <Configuration 3>

Further to the above, the safing sensor 9 is configured with the vertical acceleration sensor 7 that can detect the acceleration in a vertical direction and a vertical accelerometer 8 that can generate an actuation signal based on the vertical acceleration (or a vertical deceleration, as case may be) detected by the vertical acceleration sensor 7.

Additionally, the above-described output logic part 13 may be provided with an OR circuit 11 which outputs the actuation signal to the AND circuit 12 when the actuation signal from either the horizontal accelerometer 6 or the vertical accelerometer 8 is input into the OR circuit 11. And, the AND circuit 12 outputs the actuation signal into the actuator 14 that actuates the passenger protection device, if both actuation signals from the judgment circuit 3 in the main control part 4 and from the OR circuit 11 are input into the AND circuit 12 at the same time. As understood, the illustrated AND and OR circuits cover various actual logic gate circuitry including the use of exclusive NOR and NAND circuits.

### <Operation>

Hereinafter, the operation according to the embodiment of the present invention is described.

The actuation judgment apparatus 1 for the passenger protection control device may be operated as follows.

First, the angle speed sensor 2 detects the roll angle speed in the vehicle movement direction at the main control part 4 as shown in FIG. 1.

Then, the judgment circuit 3 calculates the roll angle by integrating the roll angle speed detected by the angle speed sensor 2; judges whether or not to actuate the passenger protection device by comparing the roll angle, the roll angle speed and the predetermined threshold y for the actuation; and generates the actuation signal if a value defined by the roll angle and the roll angle speed exceeds the predetermined threshold y.

Here, FIG. 2 is a line graph showing the threshold y for the actuation. The threshold y for the actuation is defined by the border line connecting two points. The first point is the roll angle speed value that the judgment circuit 3 judges to actuate the passenger protection device when the roll angle is 0. The second point is the roll angle value that the judgment circuit 3 judges to actuate the passenger protection device when the roll angle speed is 0. Then, the upper side of the threshold y for the actuation is an actuation field, and the lower side of the threshold y for the actuation is a un-actuation field. As shown in FIG. 2, a point or value defined by the roll angle and roll angle speed is compared to the predetermined threshold y.

Meanwhile, the horizontal acceleration sensor 5 detects the acceleration in the vehicle width direction and the horizontal accelerometer 6 generates the actuation signal based on the horizontal acceleration 6a detected by the horizontal acceleration sensor 5 at the safing sensor part 9. For instance, the horizontal accelerometer 6 judges whether or not to actuate the passenger protection device by comparing the horizontal acceleration 6a to a predetermined threshold x for the horizontal acceleration, and generates the actuation signal if the horizontal acceleration 6a exceeds the predetermined threshold x for the horizontal acceleration.

If the case where the actuation control apparatus 1 does not include the vertical acceleration sensor 7, the vertical accelerometer 8, and the OR circuit 11, the AND circuit 12 then outputs the actuation signal to the actuator 14 if both actuation signals from the judgment circuit 3 in the main control part 4 and from the horizontal accelerometer 6 in the safing sensor part 9 (the horizontal accelerometer 6 being connected to the AND circuit 12) are input into the AND circuit 12 at the same time. Thereby, the passenger protection device is actuated to protectively restrain the passenger.

Meanwhile, in a case where the sating sensor part 9 includes the vertical acceleration sensor 7 and the vertical accelerometer 8 as referred to the above, the vertical acceleration sensor 7 detects the acceleration in the vertical direction and the vertical accelerometer 8 generates the actuation signal based on the vertical acceleration detected by the vertical acceleration sensor 7 if the vertical acceleration exceeds a predetermined threshold for the vertical acceleration.

Then, the OR circuit 11 outputs the actuation signal when the actuation signal from either the horizontal accelerometer 6 or the vertical accelerometer 8 is input into the OR circuit 11 at the output logic part 13.

Next, the AND circuit 12 outputs the actuation signal to the actuator 14 if both actuation signals from the judgment circuit 3 in the main control part 4 and from the OR circuit 11 in the safing sensor part 9 are input into the AND circuit 12 at the same time. Thereby, the passenger protection device is actuated to protectively restrain the passenger.

Here, the situation where the passenger protection apparatus is actuated is roughly categorized into three conditions (rollover conditions), that is, as shown in FIG. 2, a trip-over event A, a climb-over event B and a fall-over event C. The illustrated events are only examples. Others types of events may lead to actuation and the control unit can be programmed accordingly.

A trip-over event A causes the roll angle speed to change rapidly, a climb-over event B causes the roll angle speed to change moderately, and a fall-over event C causes the roll angle speed to change slowly. Using a clear instance, the trip-over event A may be, for example, a case when a car is overturned by slamming into a curb after skidding on a corner while driving at high speed. The climb-over event B may be, for example, a case when a car is overturned after driving on two wheels by driving over a curb and/or a guardrail. The fall-over event C may be, for example, a case when a car is overturned with slipping off along a slope while driving on a bank slowly. These are just exemplary cases and it is not limited to these in practice.

The main control part 4 as referred to above is adapted to judge these three rollover conditions holistically.

Additionally, the safing sensor part 9 is configured to judge the trip-over event A with the horizontal acceleration sensor 5 and the horizontal accelerometer 6, and the climb-over event B and the fall-over event C with the vertical acceleration sensor 7 and the vertical accelerometer 8.

Because the trip-over event A is a situation that causes the roll angle speed to change rapidly as described above, the actuation of the passenger protection apparatus on the trip-over event A needs to be judged more quickly than the moderate rollover condition, such as the climb-over event B and fall-over event C.

Hence, the judgment circuit 3 operates to lower the threshold y for the actuation only during the trip-over event A, such as by changing the threshold y for the actuation to threshold y′. As a result, the actuation judgment by the main control part 4 is made quicker only in the case of the trip-over event A and not the other two events in this example.

FIG. 3 is a line graph showing a situation that the threshold y for the actuation is lowered to the threshold y′.

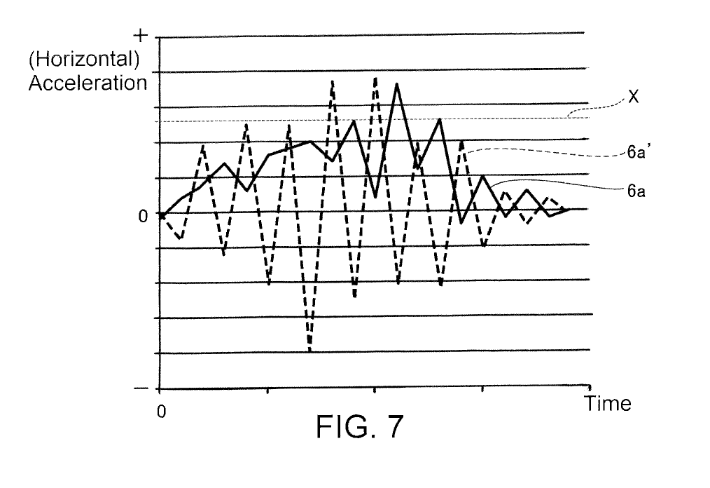

Meanwhile, when lowering the threshold y for the actuation, it is advantageous not to lower the threshold y for the actuation based on the oscillatory waveform 6a′ that is not relevant to the horizontal acceleration 6a during the trip-over event A as shown in FIG. 7. The oscillatory waveform 6a′ is generated by a comparatively major impact unaccompanied by deformation of an object and a permanent movement, such as closing a vehicle door suddenly, and punching a console, for example.

Therefore, the integrator 21 is provided in an embodiment of the present invention to integrate the horizontal acceleration 6a determined by the horizontal accelerometer 6 in the safing sensor part 9, so that the judgment circuit 3 in the main control part 4 temporarily changes the threshold y for the actuation based on the value 21a output from the integrator 21 (operation of the configuration 1).

This control using the value 21a output from the integrator 21 can be used for lowering the threshold y for the actuation as described above, and also used for raising the threshold y for the actuation in comparison.

For that case, the judgment circuit 3 in the main control part 4 is configured to lower the threshold y for the actuation when the value 21a exceeds the threshold z for the integrated value as shown in FIG. 4 (operation of the configuration 2).

The value 21a exceeds the threshold z for the integrated value because the value 21a becomes larger during the trip-over event A, whereas the value 21a′ obtained by integrating the oscillatory waveform 6a′ (dual amplitude waveform), which is not relevant to the trip-over event A, does not exceed the threshold z for the integrated value because the value 21a′ does not become larger. Accordingly, the horizontal acceleration 6a during the trip-over event A can be distinguished from the oscillatory waveform 6a′ (dual amplitude waveform) which is not relevant to the trip-over event A by using the value 21a obtained by integrating the horizontal acceleration 6a. As a result, an improper actuation of the passenger protection apparatus led by the oscillatory waveform 6a′ can be avoided, and also it becomes possible to make the actuation judgment quicker by lowering the threshold x for the horizontal acceleration.

FIG. 5 is a flowchart showing the procedure of lowering the threshold y for the actuation. At the step S1 (Integration Calculation Start), the integrator 21 calculates the value 21a by integrating the horizontal acceleration 6a. At the step S2, the judgment circuit 3 in the main control part 4 judges whether the integrated value 21a exceeds the threshold z. When the integrated value 21a exceeds the threshold z, the procedure proceeds to the step S3 so that the threshold y for the actuation is lowered by the judgment circuit 3 in the main control part 4 while the value 21a exceeds the threshold z. When the integrated value 21a no longer exceeds the threshold z, the threshold y for the actuation is raised by the judgment circuit 3 in the main control part 4 to its pre-lowered value.

The procedure at the step S2 (monitoring the value 21a) could be adapted to operate constantly as described above, but also adapted to operate only in a case where the horizontal accelerometer 6 monitors a level of the horizontal acceleration 6a and the level of the horizontal acceleration 6a exceeds a threshold for the monitoring.

### Advantageous Effect of the Embodiment

According to the above-described embodiment, one or more of the following advantageous effects can be achieved.

### <Advantageous Effect 1>

By changing the threshold y for the actuation at the judgment circuit 3 in the main control part 4 based on the value 21a obtained by integrating the horizontal acceleration 6a, it becomes possible to optimize the timing of the actuation judgment at the main control part 4 only during the trip-over event A that is highly relevant to the horizontal acceleration 6a. In other words, the actuation judgment can be optimally operated depending on the situation. For instance, the actuation judgment at the main control part 4 can be made quicker by lowering the threshold y for the actuation, meanwhile the accuracy of the actuation judgment at the main control part 4 can be increased by raising the threshold y for the actuation.

Further, the stability in operation of the actuation judgment apparatus 1 can be maintained by changing the threshold y for the actuation temporarily so as to minimize the effects of the change. That is, the actuation judgment on events other than the trip-over event A, such as the climb-over event B and the over event C, can be avoided from the effect of the change.

Furthermore, an improper actuation judgment, caused by using the horizontal acceleration 6a itself, and led by the oscillatory waveform 6a′ (dual amplitude waveform) that is not relevant to the horizontal acceleration 6a during the trip-over event A, can be avoided by using the value 21a for changing the threshold y for the actuation.

### <Advantageous Effect 2>

By lowering the threshold y for the actuation only if the value 21a, obtained by integrating the horizontal acceleration 6a, exceeds the threshold z for the integrated value, it becomes possible to make the actuation judgment at the main control part 4 quicker only during the trip-over event A that is highly relevant to the horizontal acceleration 6a.

### <Advantageous Effect 3>

As described above, in the case where the safing sensor part 9 is configured with the vertical acceleration sensor 7 that can detect the acceleration in the vertical direction and the vertical accelerometer 8 that can generate the actuation signal based on the vertical acceleration detected by the vertical acceleration sensor 7, and the output logic part 13 is configured with the OR circuit 11 that outputs the actuation signal to the AND circuit 12 when the actuation signal from either the horizontal accelerometer 6 or the vertical accelerometer 8 is input into the OR circuit 11, the AND circuit 12 is configured to output the actuation signal to the actuator 14 if both actuation signals from the judgment circuit 3 in the main control part 4 and from the OR circuit 11 are input into the AND circuit 12 at the same time. By having this configuration, the actuation judgment on the climb-over event B and the fall-over event C can also be operated in addition to the trip-over event A.

The priority application Japanese Patent Application No. 2011-113416, filed May 20, 2011 is incorporated by reference in its entirety.

While the invention has been described in detail with reference to the above-described embodiments and drawings thereof, it would be apparent to those skilled in the art that various changes and modifications may be made therein without departing from the spirit of the invention.

What is claimed is:

1. An actuation judgment apparatus for a vehicular passenger protection device comprising:
a control unit configured to judge whether to generate a first actuation signal for actuating a passenger protection device based on a roll angle speed, which judgment includes judging whether a predetermined actuation threshold has been met;
a sensor unit configured to detect a horizontal acceleration in a vehicle width direction and to generate a second actuation signal based on the horizontal acceleration; and
an output logic configured to output a third actuation signal to an actuator for actuating the passenger protection device based on the first actuation signal and the second actuation signal; and
an integrator configured to integrate the horizontal acceleration from the sensor unit to obtain an integrated value,
wherein the control unit is configured to change the predetermined actuation threshold based on the integrated value.

2. The actuation judgment apparatus according to claim 1, wherein the control unit comprises:
a roll angle sensor configured to detect a roll angle speed in a vehicle movement direction, and
a judgment circuit configured to calculate a roll angle by integrating the roll angle speed detected by the roll angle sensor, configured to judge whether to generate the first actuation signal by judging a value that is a function of the roll angle and the roll angle speed to the predetermined actuation threshold.

3. The actuation judgment apparatus according to claim 1, wherein the control unit is configured to compare the integrated value to an integrated value predetermined threshold, and to lower the predetermined actuation threshold for a time period when the integrated value exceeds the integrated value predetermined threshold.

4. The actuation judgment apparatus according to claim 3, wherein the integrated value predetermined threshold is set in order to filter out an oscillatory waveform output based on a horizontal acceleration caused by a non-trip-over event.

5. The actuation judgment apparatus according to claim 1, wherein the sensor unit comprises:
a horizontal acceleration sensor configured to detect the horizontal acceleration in the vehicle width direction; and
a horizontal accelerometer configured to generate the second actuation signal based on the horizontal acceleration detected by the horizontal acceleration sensor,
wherein the integrator is configured to integrate at least one of the horizontal acceleration detected by the horizontal acceleration sensor or the horizontal acceleration from the horizontal accelerometer to obtain the integrated value.

6. The actuation judgment apparatus according to claim 1, wherein the output logic comprises an AND circuit configured to output the third actuation signal to the actuator for actuating the passenger protection device when both the first actuation signal and the second actuation signal are input into the AND circuit at a same time.

7. The actuation judgment apparatus according to claim 1, wherein the sensor unit is configured to detect a vertical acceleration in a vertical direction and to generate a fourth actuation signal based on the vertical acceleration, and
wherein the output logic is configured to output a fifth actuation signal based on the second actuation signal and the fourth actuation signal and to output the third actuation signal to the actuator based on both the first actuation signal and the fifth actuation signal.

8. The actuation judgment apparatus according to claim 7, wherein the output logic comprises an OR circuit configured to output the fifth actuation signal when either of the second actuation signal or the fourth actuation signal is input into the OR circuit, and an AND circuit configured to output the third actuation signal to the actuator when both the first actuation signal and the fifth actuation signal are input into the AND circuit at a same time.

9. The actuation judgment apparatus according to claim 1, wherein the control unit is configured to temporarily lower the predetermined actuation threshold based on the integrated value.

10. An actuation judgment apparatus for a vehicular passenger protection device comprising:
a judgment circuit configured to calculate a roll angle by integrating a roll angle speed, configured to judge whether to generate a first actuation signal for actuating a passenger protection device based on the roll angle, and configured to generate a first actuation signal based on the judgment;
a safing sensor unit configured to detect a horizontal acceleration in a vehicle width direction and to generate a second actuation signal based on the horizontal acceleration determined to be indicative of a trip-over event;
a circuit configured to output a third actuation signal to an actuator for actuating the passenger protection device based on the first actuation signal and the second actuation signal; and
an integrator configured to integrate the horizontal acceleration detected by the safing sensor unit to obtain an integrated value, and
wherein the judgment circuit is configured to change a predetermined actuation threshold for actuation of the passenger protection device based on the integrated value indicating a trip-over event.

11. The actuation judgment apparatus according to claim 10, wherein the judgment circuit includes the integrator, is configured to compare the integrated value to an integrated value predetermined threshold, and is configured to lower the predetermined actuation threshold during a time period when the integrated value exceeds the integrated value predetermined threshold that indicates a trip-over event.

12. The actuation judgment apparatus according to claim 11, wherein the integrated value predetermined threshold is set in order to filter out an oscillatory waveform output based on a horizontal acceleration caused by a non-trip-over event.

13. The actuation judgment apparatus according to claim 10, further comprising:
a vertical acceleration sensor configured to detect a vertical acceleration in a vertical direction; and
a vertical accelerometer configured to generate a fourth actuation signal based on the vertical acceleration detected by the vertical acceleration sensor,
wherein the circuit comprises an AND circuit, wherein the actuation judgment apparatus further comprises an OR circuit configured to output a fifth actuation signal when either of the second actuation signal or the fourth actuation signal is input into the OR circuit, and wherein the AND circuit is configured to output the third actuation signal to the actuator when both the first actuation signal and the fifth actuation signal are input into the AND circuit at the same time.

14. A method for actuating of a passenger protection device comprising:
generating a first actuation signal for actuating a passenger protection device based on a roll angle speed, which judgment includes judging whether a predetermined actuation threshold has been met;
generating a second actuation signal based on a horizontal acceleration;
outputting a third actuation signal based on the first actuation signal and the second actuation signal;
integrating the horizontal acceleration so as to obtain an integrated value;
changing the predetermined actuation threshold for actuation of the passenger protection device based on the integrated value; and
actuating the passenger protection device based on the third actuation signal.

15. The method according to claim 14, further comprising comparing the integrated value to an integrated value predetermined threshold, and
wherein the step of changing the actuation threshold comprises lowering the actuation threshold for actuation during a time period when the integrated value exceeds the integrated value predetermined threshold.

16. The method according to claim 15, wherein the integrated value predetermined threshold is set such that exceeding the integrated value predetermined threshold indicates that a trip-over event has occurred.

17. The method according to claim 15, wherein the integrated value predetermined threshold is set in order to filter out an oscillatory waveform output based on a horizontal acceleration caused by a non-trip-over event.

18. The method according to claim 15, wherein the step of comparing is performed continuously.

19. The method according to claim 16, wherein the step of comparing is performed when the horizontal acceleration exceeds an acceleration threshold.

20. The method according to claim 14, wherein the step of changing the actuation threshold comprises temporarily lowering the actuation threshold for actuation of the passenger protection device based on the integrated value.
